(19) United States
(12) Patent Application Publication
(10) Pub. No.: US 2022/0126975 A1
(43) Pub. Date: Apr. 28, 2022

(54) EJECTION SYSTEM FOR AN EMERGENCY EXIT OF A VEHICLE

(71) Applicant: VISION SYSTEMS, BRIGNAIS (FR)

(72) Inventors: Philippe BENENTENDI, CHAPONOST (FR); Mathieu SIMON, CALUIRE (FR)

(21) Appl. No.: 17/429,082

(22) PCT Filed: Feb. 4, 2020
(86) PCT No.: PCT/FR2020/050180

§ 371 Date: Aug. 6, 2021

(30) Foreign Application Priority Data
Feb. 6, 2019 (FR) 19/01157

(51) Int. Cl. B64C 1/32; B64D 45/00

(52) U.S. Cl. CPC B64C 1/32; B64D 45/0005

(57) ABSTRACT

Ejection system for a vehicle emergency exit ejection system for a vehicle emergency exit, the emergency exit extending along a base surface and being designed to cooperate in a mounted position with a receiving frame of the vehicle, the ejection system including a retaining element and a locking mechanism designed to cooperate with the retaining element in a locking configuration in which a movable part of the locking mechanism prevents a relative movement of the retaining element and the locking mechanism in a direction of ejection of the emergency exit which is transversal to the base surface, the movable part being configured to be moved in a closing plane that extends transversally to the base surface and an ejection configuration in which the locking mechanism is capable of moving in the direction of ejection relative to the retaining element.

### CROSS REFERENCE TO RELATED APPLICATIONS

This application is a National Stage of PCT Application No. PCT/FR2020/050180 filed on Feb. 4, 2020, which claims priority to French Patent Application No. 19/01157 filed on Feb. 6, 2019, the contents each of which are incorporated herein by reference thereto.

### FIELD OF THE INVENTION

The present invention concerns an ejection system for an emergency exit of a vehicle.

### BACKGROUND

It is known to provide a vehicle with an emergency exit adapted to be ejected to the outside of the vehicle.

In the case of a helicopter, the emergency exit may be a window comprising a pane which may be detached from a receiving frame of the vehicle in case of emergency.

The emergency exit is ejected to the outside of the vehicle in order to enable an occupant to come out from the vehicle. Thus, it is necessary to use an ejection system adapted to operate independently of the other functions of the vehicle.

Mechanical ejection systems comprising an actuation handle exist and are satisfactory since no electric energy source is required for the operation of these ejection systems.

These ejection systems are also used to achieve fastening of the emergency exit in the receiving frame. They are satisfactory since they fasten the emergency exit to the receiving frame while allowing for a quick ejection.

Nonetheless, these mechanical ejection systems may turn out to be voluminous in particular by extending parallel to the extension surface of the emergency exit inside the receiving frame and/or the emergency exit.

The present invention aims at solving all or part of the above-mentioned drawbacks.

### BRIEF SUMMARY

To this end, the present invention concerns an ejection system for an emergency exit of a vehicle, the emergency exit extending according to a base surface and being arranged so as to cooperate in a mounted position with a receiving frame of the vehicle, the ejection system comprising a retaining element and a blocking mechanism arranged so as to cooperate with the retaining element according to a blocking configuration in which a movable portion of the blocking mechanism prevents a relative displacement of the retaining element and of the blocking mechanism according to an ejection direction of the emergency exit which is transverse to the base surface, the movable portion being configured to be displaced in a closure plane extending transversely to the base surface, and an ejection configuration in which the blocking mechanism is adapted to be displaced according to the ejection direction relative to the retaining element.

The movable portion being displaced transversely to the base plane the ejection system has a reduced bulk according to the base surface, that is to say transversely to the ejection direction.

In other words, the movements of the movable portions being located across the thickness of the emergency exit or of the receiving frame, is substantially parallel to the ejection direction.

Hence, this arrangement allows easily integrating the blocking mechanism on a flange of the emergency exit or in the receiving frame.

The present invention also concerns an emergency set comprising the ejection system, the receiving frame and the emergency exit. Thus, the vehicle may comprise one or several emergency set(s).

According to an aspect of the invention, the vehicle is a rail vehicle, a motor-propelled vehicle such as a camping car or an aircraft, preferably a helicopter.

Preferably, the emergency exit is a door and/or a window and comprising in particular a pane.

According to an aspect of the invention, the movable portion comprises a jaw configured to pivot about a closure axis which is transverse to the closure plane.

This arrangement allows for an easy switch from the ejection configuration into the blocking configuration during set-up of the emergency exit on the vehicle. Indeed, a sufficient backlash exists between the jaw and the retaining element to enable a proper relative positioning of these two parts. Thus, a perfect alignment is not necessary.

According to an aspect of the invention, the blocking mechanism features, in the ejection configuration, a through opening extending partially transversely to the closure axis and partially transversely to the ejection direction.

This arrangement allows for an easy switch from the dismounted position into the mounted position since the opening extends according to two substantially orthogonal dimensions.

Preferably, the through opening is formed in a wall transverse to the closure axis and another wall partially transverse to the ejection direction.

According to an aspect of the invention, the retaining element comprises a rod extending substantially parallel to the closure axis, the rod being adapted to cooperate with the jaw. Preferably, the rod is blocked by the jaw according to the ejection direction in the blocking configuration.

According to an aspect of the invention, when the emergency exit is in the dismounted position and the blocking mechanism in the blocking configuration, the retaining element is configured to cooperate with the movable portion so as to dispose the movable portion in the ejection configuration

In other words, it is possible to mount the emergency exit to the frame even when the blocking mechanism is in the blocking configuration. This arrangement facilitates the set-up of the emergency exit in the frame.

According to an aspect of the invention, the movable portion comprises an additional jaw configured to pivot about an additional closure axis. Preferably, the jaw and the additional jaw are arranged so as to surround at least one portion of the retaining element. In particular, the jaw cooperates with the additional jaw so that the jaw drives the additional jaw in rotation.

According to an aspect of the invention, the direction of rotation of the jaw is opposite to the direction of rotation of the additional jaw.

Preferably, the jaw has a first gear portion arranged so as to cooperate with a second gear portion of the additional jaw. In particular, the closure axis and the additional closure axis are distant from one another.

According to an aspect of the invention, the movable portion has an actuation stop configured to cooperate with the retaining element during a displacement of the emergency exit from a dismounted position to the mounted position so as to switch from the ejection configuration into the blocking configuration when the mounted position is reached.

This arrangement enables an automatic switch into the blocking configuration when the emergency exit is installed on the receiving frame.

Preferably, the actuation stop is attached on or formed in the jaw. In particular, during the switch from the dismounted position into the mounted position, the rod cooperates with the jaw so as to make the jaw pivot up to the blocking configuration.

This arrangement allows limiting the number of used parts meaning that it is not necessary to provide an additional part to displace the jaw from the ejection configuration into the blocking configuration.

According to an aspect of the invention, the actuation stop is arranged so as to cooperate with the retaining element during a switch from the blocking configuration into the ejection configuration so as to cause a relative displacement of the retaining element according to the ejection direction.

Another function of the actuation stop is to displace the blocking mechanism relative to the retaining element during the ejection of the emergency exit.

Thus, when the emergency exit has to be ejected from the receiving frame, the switch from the blocking configuration into the ejection configuration allows displacing the window slightly towards the dismounted position so that the user no longer has to push the emergency exit according to the ejection direction to switch into the dismounted position.

According to an aspect of the invention, the blocking mechanism comprises a lock configured to cooperate with the movable portion in a locked position in which the movable portion is held in the blocking configuration.

This arrangement allows avoiding every undesired switch from the blocking configuration into the ejection configuration. Thanks to the lock, a user pressing on the emergency exit in the ejection direction does not cause a switch into the dismounted position.

According to an aspect of the invention, the blocking mechanism comprises a locking device arranged so as to dispose the lock in the locked position when the blocking mechanism is in the blocking configuration.

This arrangement allows securing the emergency exit on the receiving frame. Once disposed in the mounted position, the blocking configuration is easily locked thanks to the locking device.

According to an aspect of the invention, the locking device comprises a visual indicator configured to notify the proper positioning of the lock in the locked position.

This arrangement allows ensuring, by visual check-up, that there is no risk of undesired ejection of the emergency exit. Preferably, the visual indicator is a colored surface.

According to an aspect of the invention, the locking device comprises a rotary actuator configured to cooperate with the lock, the rotary actuator being secured to the visual indicator.

Thus, the visual indicator is reliable since its position depends on the state of the rotary actuator. Thus, the reliability of the visual indicator is increased.

Preferably, the rotary actuator comprises a location for receiving a tool configured to cause the rotation. Preferably, the receiving location corresponds to a hex key.

This arrangement allows having a locking device with a small bulk and in particular without a lever.

According to an aspect of the invention, the lock has a drive surface configured to cooperate with the movable portion during a switch from the locked position into an unlocked position so as to make the movable portion switch from the blocking configuration into the ejection configuration.

This arrangement enables triggering of the ejection of the emergency exit by only displacing the lock. Indeed, the displacement of the lock has a first effect which consists in switching from the locked position into the unlocked position.

Furthermore, the drive surface allows displacing the movable portion at the same time in order to switch from the blocking configuration into the ejection configuration.

According to an aspect of the invention, the blocking mechanism has a rail arranged to guide the lock between the locked position and the unlocked position and vice versa. This arrangement allows securing the displacement of the lock, which improves the reliability of the ejection system.

According to an aspect of the invention, the lock is configured to be disposed in an intermediate position between the unlocked position and the locked position, the intermediate position resulting from the arrangement of the emergency exit from the dismounted position into the mounted position.

Thus, during the set-up of the emergency exit, it is necessary to displace the lock from the intermediate position towards the locked position.

Thus, this arrangement allows for an easy and reliable mounting of the emergency exit since the user has to ensure himself that the set is actually in the locked position after having mounted the emergency exit in the receiving frame.

According to an aspect of the invention, the movable portion has a projection arranged so as to cooperate on the one hand with a locking surface of the lock in the locked position and with the drive surface during unlocking.

Hence, the projection allows ensuring two functions: locking and switching into the ejection configuration.

The lock has a notch into which the projection is inserted. The drive surface and the locking surface are formed opposite one another one either side of the notch.

According to an aspect of the invention, the retaining element is configured to be attached on or formed in the receiving frame and wherein the blocking mechanism is configured to be attached on or formed in the emergency exit.

This arrangement allows designing an ejection system almost fully adapted to be integrated in a flange of the emergency exit since only the retaining element is on the receiving frame.

Moreover, the ejection system extends across the thickness of the emergency exit by its design, which allows limiting the extension of the flange according to the base surface.

According to another aspect of the invention, the blocking mechanism is configured to be attached on or formed in the receiving frame and in which the retaining element is configured to be attached on or formed in the emergency exit.

Depending on the geometric constraints, it is also possible to provide for the integration of the blocking mechanism in the receiving frame.

According to an aspect of the invention, the ejection system comprises a plurality of retaining elements and a plurality of corresponding blocking mechanisms, the ejection system further comprising a triggering device arranged so as to carry out the switch from the blocking configuration into the ejection configuration of the plurality of blocking mechanisms.

This arrangement enables the ejection system to achieve holding of the emergency exit in position in the receiving frame. No other system for fastening to the receiving frame is necessary for the emergency exit.

In addition, the triggering device allows disposing the plurality of blocking mechanism in the ejection configuration in one single operation.

According to an aspect of the invention, when at least one blocking mechanism comprises a lock as described hereinbefore, the triggering device is arranged so as to displace said lock from the locked position into unlocked position.

According to an aspect of the invention, when each blocking mechanism comprises a corresponding lock, the triggering device is arranged to displace each lock from the locked position into the unlocked position.

Thus, the use of locks does not prevent the triggering device from operating.

According to an aspect of the invention, the triggering device comprises one or several cable(s), a mechanism for tensioning the cable(s) arranged so as to trigger the switch from the blocking configuration into the ejection configuration upon tensioning, and, at least one actuation handle.

In other words, triggering is mechanical, tensioning corresponding to pulling of the cable(s). By cable, it should be understood a wire or a rope adapted to be tensioned.

This arrangement allows for a simple actuation of the triggering device by tensioning of the cable(s) by pulling on the actuation handle.

According to an aspect of the invention, the tensioning mechanism comprises a pulley configured to enable tensioning of the cable(s) when a user pulls on the actuation handle.

This arrangement allows pulling the actuation handle in any direction because the pulley allows tensioning the cable(s) in all cases.

According to an aspect of the invention, the tensioning mechanism comprises a rotary link part connected to the pulley so as to enable tensioning of at least two cables, each of the at least two cables being connected to one end of the rotary link part.

This arrangement allows tensioning the two cable(s) by pulling thereon according to two opposite directions. Thus, the tensioning mechanism allows adapting to different types of spatial configurations between the blocking mechanisms.

According to an aspect of the invention, the cable(s) are arranged so as to cooperate with the blocking mechanisms of the blocking mechanisms so as to displace the movable portions of the plurality of the blocking mechanisms.

According to an aspect of the invention, the cable(s) are arranged so as to be connected to one or several lock(s) of corresponding blocking mechanisms.

Preferably, the switch of the blocking mechanisms from the blocking configuration into the ejection configuration by the arrangement of the locks from the locked position into the unlocked position by the cable(s).

According to an aspect of the invention, the ejection of the emergency exit is done towards the outside of the vehicle according to the ejection direction.

Preferably, the actuation handle(s) are disposed on the interior side and/or on the exterior side of the vehicle.

The different aspects defined hereinabove that are not incompatible may be combined.

### BRIEF DESCRIPTION OF THE FIGURES

The invention will be better understood from the detailed description that is disclosed hereinbelow with reference to the appended drawings.

FIG. 1 is a perspective view of a portion of a vehicle comprising an emergency exit and a receiving frame.

FIG. 2 is a perspective view of a blocking mechanism of an ejection system.

FIG. 3 is a perspective view of the ejection system.

FIG. 4 is a perspective view of the ejection system.

FIG. 5 is a perspective view of a locking device of the blocking mechanism.

FIG. 6 is a top view of the ejection system in an ejection configuration

FIG. 7 is a top view of the ejection system in a blocking configuration.

FIG. 8 is a detail perspective view of the ejection system.

FIG. 9 is a schematic view of a triggering device of the ejection system.

### DETAILED DESCRIPTION

In the following detailed description of the figures defined hereinabove, the same elements or the elements filling identical functions may keep the same reference numerals so as to simplify understanding of the invention.

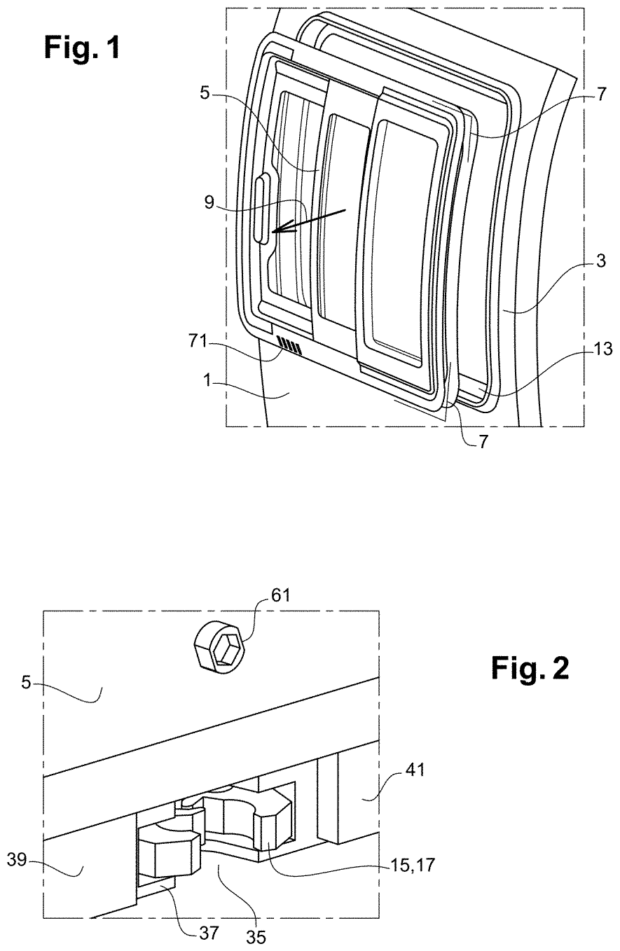

As illustrated in FIG. 1, a vehicle 1 comprises a receiving frame 3 and an emergency exit 5 configured to cooperate with the receiving frame 3 in a mounted position.

In this instance, the vehicle 1 is an aircraft and more particularly a helicopter. The emergency exit 5 may be a door or a window comprising a pane as illustrated in FIG. 1.

The emergency exit 5 extends according to a base surface 7 which may be substantially planar and for example slightly curved.

The emergency exit 5 is configured to be ejected from the receiving frame 3 towards the outside of the vehicle according to an ejection direction 9, the base surface 7 being transverse to the ejection direction 9.

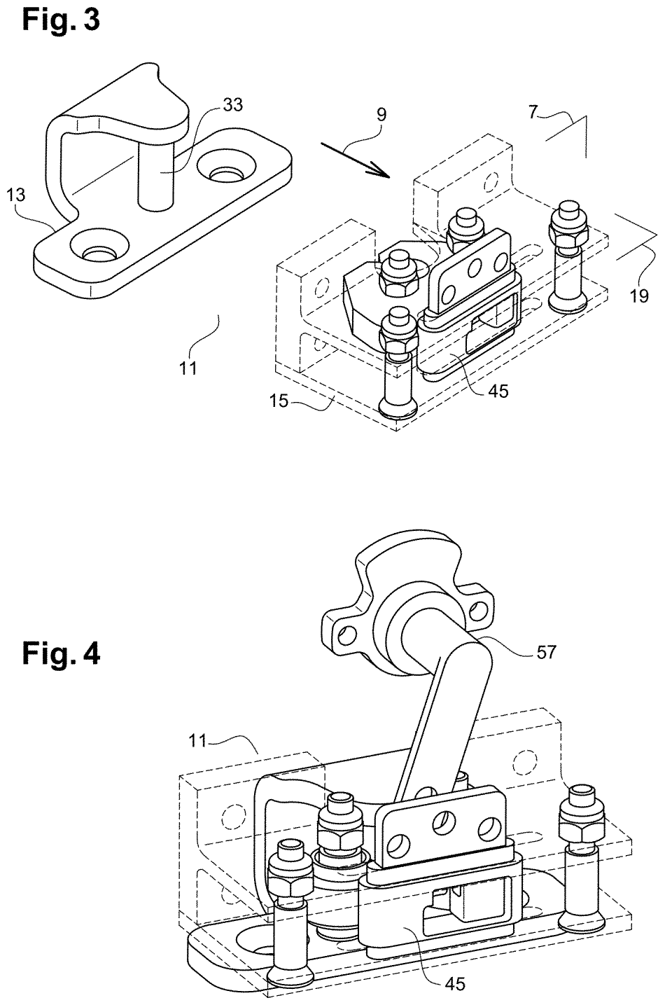

As illustrated in FIGS. 2 to 8, the ejection system 11 is arranged so as to displace the emergency exit 5 relative to the receiving frame 3 from a mounted position to a dismounted position.

The ejection system 11 is also configured to enable a switch from the dismounted position into the mounted position upon set-up of the emergency exit 5 on the vehicle 1.

The ejection system 11 comprises a retaining element 13 attached on the receiving frame 3 and a corresponding blocking mechanism 15 formed in the emergency exit 5.

Alternatively, it is also possible to provide for a retaining element 13 attached on the emergency exit 5 and a blocking mechanism 15 formed in the receiving frame 3.

An emergency set comprises the ejection system 11, the receiving frame 3 and the emergency exit 5. Thus, the vehicle 1 may comprise one or several emergency exit(s).

The blocking mechanism 15 comprises a movable portion 17 configured to be displaced in a closure plane 19 extending transversely to the base surface 7.

The movable portion 17 comprises a jaw 21 configured to pivot about a closure axis 23, the closure plane 19 being transverse to the closure axis 23.

The movable portion 17 further comprises an additional jaw 25 configured to pivot about an additional closure axis 27 parallel to the closure axis 23.

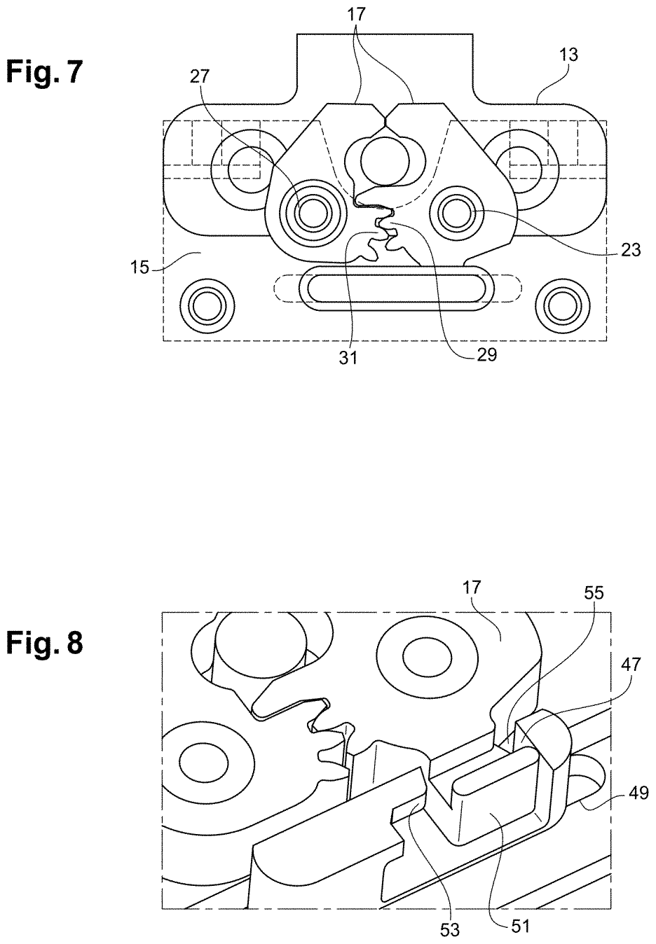

The jaw 21 and the additional jaw 25 are arranged so as to surround at least one portion of the retaining element 13 in a blocking configuration as illustrated in FIG. 7.

Thus, in the blocking configuration, the movable portion 17 prevents the relative displacement of the retaining element 13 and of the blocking mechanism 15 according to the ejection direction 9.

The jaw 21 cooperates with the additional jaw 25 so that the jaw 21 drives the additional jaw 25 in rotation. The direction of rotation of the jaw 21 is opposite to the direction of rotation of the additional jaw 25.

The jaw 21 has a first gear portion 29 arranged so as to cooperate with a second gear portion 31 of the additional jaw 2.

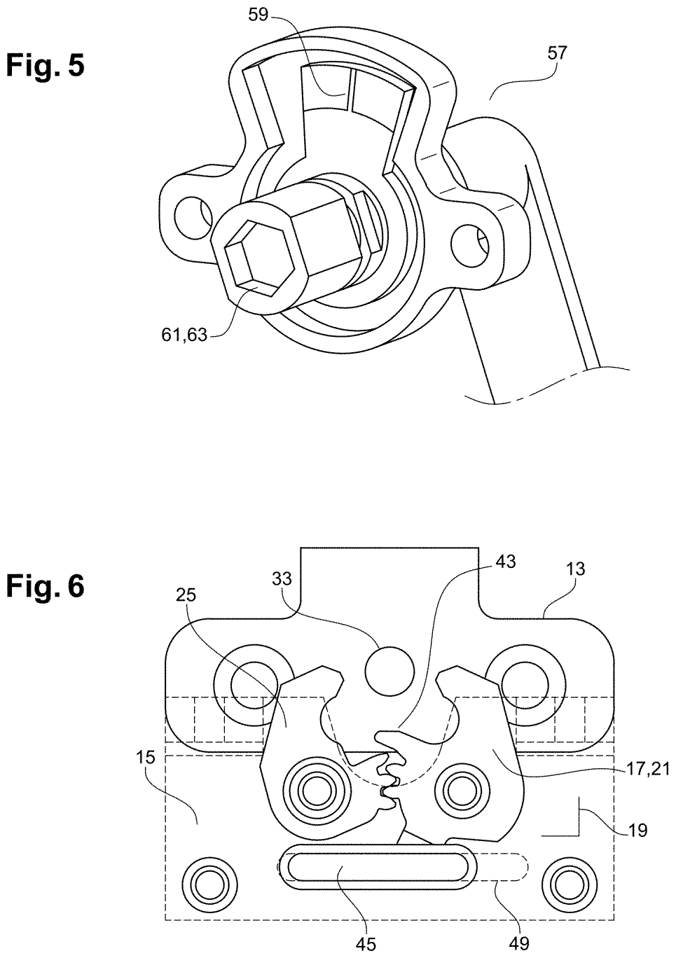

As illustrated in FIG. 6, the retaining element 13 and the blocking mechanism 15 may also cooperate according to an ejection configuration in which the retaining element 13 is adapted to be displaced according to the ejection direction 9.

It should be highlighted that the movable portion 17 may be disposed in the ejection configuration by the retaining element 13 upon installation of the emergency exit 5 in the receiving frame 3 when the jaw 21 and the additional jaw 25 are closed.

Indeed, the retaining element 13 comprises a rod 33 extending substantially parallel to the closure axis 23 and allowing opening the jaw 21 and the additional jaw 25.

As illustrated in FIG. 2, the blocking mechanism 15 has a through opening 35 formed in a wall 37 which is transverse to the closure axis 23 and in another wall 39 which is transverse to the ejection direction 9.

The wall 37 and the other wall 39 are formed in an edge 41 of the emergency exit 5.

Thus, the through opening 35 is transverse to the closure axis 23 and to the ejection direction 9 so as to allow for a slight backlash in the cooperation between the retaining element 13 and the blocking mechanism 15 for easy installation and ejection.

As illustrated in FIGS. 6 and 7, the movable portion 17 has an actuation top 43 formed in the jaw 21. The actuation stop 43 has two roles.

A first role consists, for the actuation stop 43, in cooperating with the retaining element 13 during a displacement of the emergency exit 5 from a dismounted position to the mounted position so as to switch from the ejection configuration into the blocking configuration when the mounted position is reached

In this manner, the blocking mechanism 15 is automatically disposed in the blocking configuration upon mounting the emergency exit 5.

A second role consists, for the actuation stop 43, in cooperating with the retaining element 13 during a switch from the blocking configuration into the ejection configuration so as to cause a relative displacement of the retaining element 13 according to the ejection direction 9.

Thus, the ejection of the emergency exit 5 is assisted by the actuation stop 43 which displaces the retaining element 13 relative to the blocking mechanism 15.

The blocking mechanism 15 also comprises a lock 45 arranged so as to cooperate with the movable portion 17 in order to keep the blocking configuration. The lock 45 is then in the locked position.

The lock 45 has a drive surface 47 configured to cooperate with the movable portion 17 during a switch from the locked position into the unlocked position so as to make the movable portion 17 switch from the blocking configuration into the ejection configuration.

The blocking mechanism 15 comprises a rail 49 arranged so as to guide the lock 45 between the locked position and the unlocked position and vice versa. The lock 45 is configured to be disposed in an intermediate position between the unlocked position and the unlocked position.

The intermediate position is reached upon arrangement of the emergency exit 5 during the switch from the dismounted position into the mounted position.

The intermediate position is shown in FIGS. 7 and 8. The unlocked position is that one of FIG. 6. When the lock 45 is disposed at the end of travel on the right side of the rail 49 in FIG. 8, it is in the locked position.

As also shown in FIG. 8, the movable portion 17 has a projection 51 arranged so as to cooperate, on the one hand, with a locking surface 53 of the lock 45 in the locked position and with the drive surface 47 during unlocking.

Hence, the projection 51 allows filling two functions: the locking and the switch into the ejection configuration.

The lock 45 has a notch 55 into which the projection 51 is inserted. The drive surface 47 and the locking surface 53 are formed opposite one another on each side of the notch 55.

As illustrated in FIGS. 4 and 5, the blocking mechanism 15 comprises a locking device 57 arranged so as to dispose the lock 45 in the locked position. Hence, the locking device 57 is used during mounting of the emergency exit in the receiving frame

The locking device 57 comprises a visual indicator 59 configured to notify the proper positioning of the lock 45 in the locked position. The locking device 7 also comprises a rotary actuator 61 configured to cooperate with the lock 45 and secured to the visual indicator 59.

Thus, the visual indicator 59 is reliable since its position depends on the state of the rotary actuator 61.

The rotary actuator 61 comprises a location 63 for receiving a tool configured to cause the rotation. The receiving location 63 corresponds to a hex key.

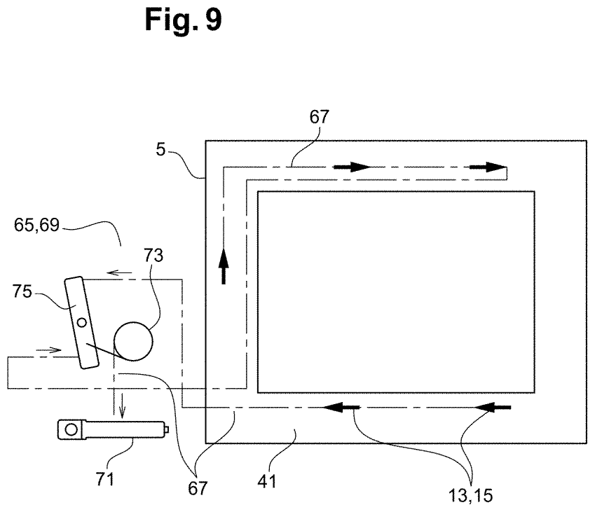

As illustrated in FIG. 9, the ejection system 11 comprises a plurality of retaining elements 13 and a plurality of corresponding blocking mechanisms 15 as described hereinabove and distributed along the flange 41 of the emergency exit 5.

The ejection system 11 further comprises a triggering device 63 arranged so as to carry out the switch from the blocking configuration into the ejection configuration of the plurality of blocking mechanisms 15.

The triggering device 65 allows disposing the plurality of blocking mechanism 15 in the ejection configuration in one single operation.

The triggering device 65 comprises cables 67, a mechanism 69 for tensioning the cables 67 arranged so as to trigger the switch from the blocking configuration into the ejection configuration upon tensioning.

The triggering device 45 also comprises at least one actuation handle 71 which may be external and/or internal.

In other words, the triggering is mechanical, the tensioning corresponding to tensioning of the cables. By cable, it should be understood a wire or a rope adapted to be tensioned.

The tensioning mechanism 69 comprises a pulley 73 configured to enable tensioning of the cables 67 when a user pulls on the actuation handle 71.

This arrangement allows pulling the actuation handle 71 in any direction because the pulley 73 allows tensioning the cables in all cases.

The tensioning mechanism 69 comprises a rotary link part 75 connected to the pulley 73 so as to enable tensioning of at least two cables 67, each of the at least two cables 67 being connected to one end of the rotary link part 75.

This arrangement allows tensioning the at least two cables 67 by pulling thereon according to two opposite directions. Thus, the tensioning mechanism 69 allows adapting to different types of spatial configurations between the blocking mechanisms 15.

The ejection system 11 described this way enables fastening of the emergency exit 5 to the receiving frame 3. The ejection is also facilitated since all it needs is to pull the at least one actuation handle 71 in any direction.

The fact that the movable portion 17 is arranged so as to be movable in the closure plane 19 allows saving space parallel to the base surface 7 and thus designing a barely cumbersome ejection system 11.

It clearly appears that the thickness of the flange 41 of the emergency exit is sufficient to house the blocking mechanism.

It goes without saying that the invention is not limited to only this embodiment described hereinabove as example, it encompasses, on the contrary, all variants thereof.

1. An ejection system for an emergency exit of a vehicle, the emergency exit extending according to a base surface and being arranged so as to cooperate in a mounted position with a receiving frame of the vehicle, the ejection system comprising a retaining element and a blocking mechanism arranged so as to cooperate with the retaining element according to:
a blocking configuration in which a movable portion of the blocking mechanism prevents a relative displacement of the retaining element and of the blocking mechanism according to an ejection direction of the emergency exit which is transverse to the base surface, the movable portion being configured to be displaced in a closure plane extending transversely to the base surface, and
an ejection configuration in which the blocking mechanism is adapted to be displaced according to the ejection direction relative to the retaining element.

2. The ejection system according to claim 1, wherein the movable portion comprises a jaw configured to pivot about a closure axis which is transverse to the closure plane.

3. The ejection system according to claim 1, wherein the movable portion has an actuation stop configured to cooperate with the retaining element during a displacement of the emergency exit from a dismounted position to the mounted position so as to switch from the ejection configuration into the blocking configuration when the mounted position is reached.

4. The ejection system according to claim 3, wherein the actuation stop is arranged so as to cooperate with the retaining element during a switch from the blocking configuration into the ejection configuration so as to cause a relative displacement of the retaining element according to the ejection direction.

5. The ejection system according to claim 1, wherein the blocking mechanism comprises a lock configured to cooperate with the movable portion in a locked position in which the movable portion is held in the blocking configuration.

6. The ejection system according to claim 5, wherein the blocking mechanism comprises a locking device arranged so as to dispose the lock in the locked position when the blocking mechanism is in the blocking configuration.

7. The ejection system according to claim 6, wherein the locking device comprises a visual indicator configured to notify the proper positioning of the lock in the locked position.

8. The ejection system according to claim 7, wherein the locking device comprises a rotary actuator configured to cooperate with the lock, the rotary actuator being secured to the visual indicator.

9. The ejection system according to claim 5, wherein the lock has a drive surface configured to cooperate with the movable portion during a switch from the locked position into an unlocked position so as to make the movable portion switch from the blocking configuration into the ejection configuration.

10. The ejection system according to claim 1, wherein the retaining element is configured to be attached on or formed in the receiving frame and wherein the blocking mechanism is configured to be attached on or formed in the emergency exit.

11. The ejection system according to claim 1, comprising a plurality of retaining elements and a plurality of corresponding blocking mechanisms, the ejection system further comprising a triggering device arranged so as to carry out a switch from the blocking configuration into the ejection configuration of the plurality of blocking mechanisms.

12. The ejection system according to claim 11, wherein the triggering device comprises one or several cable(s), a mechanism for tensioning the cable(s) arranged so as to trigger the switch from the blocking configuration into the ejection configuration upon tensioning, and, at least one actuation handle.

13. The ejection system according to claim 2, wherein the movable portion has an actuation stop configured to cooperate with the retaining element during a displacement of the emergency exit from a dismounted position to the mounted position so as to switch from the ejection configuration into the blocking configuration when the mounted position is reached.

14. The ejection system according to claim 13, wherein the actuation stop is arranged so as to cooperate with the retaining element during a switch from the blocking configuration into the ejection configuration so as to cause a relative displacement of the retaining element according to the ejection direction.

15. The ejection system according to claim 14, wherein the blocking mechanism comprises a lock configured to cooperate with the movable portion in a locked position in which the movable portion is held in the blocking configuration.

16. The ejection system according to claim 15, wherein the blocking mechanism comprises a locking device arranged so as to dispose the lock in the locked position when the blocking mechanism is in the blocking configuration.

17. The ejection system according to claim 16, wherein the locking device comprises a visual indicator configured to notify the proper positioning of the lock in the locked position.

18. The ejection system according to claim 17, wherein the locking device comprises a rotary actuator configured to cooperate with the lock, the rotary actuator being secured to the visual indicator.

19. The ejection system according to claim 18, wherein the lock has a drive surface configured to cooperate with the movable portion during a switch from the locked position into an unlocked position so as to make the movable portion switch from the blocking configuration into the ejection configuration.

20. The ejection system according to claim 19, wherein the retaining element is configured to be attached on or formed in the receiving frame and wherein the blocking mechanism is configured to be attached on or formed in the emergency exit.
